(19) United States
(12) Patent Application Publication
(10) Pub. No.: US 2026/0105375 A1
(43) Pub. Date: Apr. 16, 2026

(54) GENERATING PERSONALIZED CONTENT RECOMMENDATIONS FOR USERS

(71) Applicant: NETFLIX, INC., Los Gatos, CA (US)

(72) Inventors: Yuta SAITO, Los Gatos, CA (US); Gary TANG, Los Gatos, CA (US); Lequn WANG, Jersey City, NJ (US); Dawen LIANG, Santa Clara, CA (US); Ding TONG, San Mateo, CA (US); Justin Derrick BASILICO, Los Gatos, CA (US)

(21) Appl. No.: 19/354,781

(22) Filed: Oct. 9, 2025

Related U.S. Application Data
(60) Provisional application No. 63/706,253, filed on Oct. 11, 2024.

(51) Int. Cl. G06N 20/00; G06F 16/9535

(52) U.S. Cl. CPC G06N 20/00; G06F 16/9535

(57) ABSTRACT

One embodiment sets forth a method for generating a trained recommendation model. According to some embodiments, the method can be implemented by a computing device, and includes the steps of receiving user interaction data for a plurality of users; generating a plurality of user cohorts based on the user interaction data; assigning, to each user cohort in the plurality of user cohorts, a personalized proxy reward function; generating, for each user cohort included in the plurality of user cohorts, an expected long-term reward for the user cohort based on the personalized proxy reward function; and for each user cohort included in the plurality of user cohorts, updating the personalized proxy reward function based on the expected long-term reward for the user cohort, and generating a recommendation policy based on the personalized proxy reward function for the user cohort.

### CROSS-REFERENCE TO RELATED APPLICATIONS

This application claims priority benefit of the United States Provisional patent application titled, “TECHNIQUES FOR GENERATING CONTENT RECOMMENDATIONS FOR USERS,” filed on Oct. 11, 2024, and having Ser. No. 63/706,253. The subject matter of this related application is hereby incorporated by reference.

### BACKGROUND OF THE INVENTION

### Field of the Invention

Embodiments of the present disclosure relate generally to computer science, machine learning, streaming and video processing technologies, and, more specifically, to generating personalized content recommendations for users.

### Description of the Related Art

Recommendation systems often employ machine learning approaches that consider a user's past behavior to provide personalized recommendations. Recommendation systems are widely used in applications that involve audio or video streaming services, social media platforms, and e-commerce. For example, recommendation systems can be utilized to suggest movies and TV shows and to match customers with products and services during online shopping.

Traditional recommendation systems utilize one of two primary approaches: content filtering or collaborative filtering. Content filtering involves training machine learning models to recommend items with similar attributes or features to items with which a user has previously interacted or shown interest. For example, on a video streaming service, a content filtering algorithm may recommend a movie of a similar genre or with a similar cast to a movie previously viewed by a user. Collaborative filtering involves training machine learning models to recommend items that are popular among users who possess similar preferences. Collaborative filtering techniques analyze information associated with many users, including star ratings on movies or products purchased across many items, to provide recommendations to a user with similar preferences. For instance, on an e-commerce platform, a collaborative filtering algorithm may recommend a product based on the purchases of users with similar shopping histories.

One drawback of traditional recommendation systems is that traditional recommendation systems may not fully capture long-term user engagement, such as time spent in an application, watching a video to completion, or renewing a subscription. This arises, at least in part, because the training of such systems maximizes short-term rewards of the recommendations. Examples include skips, plays, thumbs up/down evaluations, or adding items to a playlist. However, optimizing for short-term user engagement may not enhance the long-term satisfaction of the user. Additionally, directly optimizing long-term rewards of the recommendation poses challenges, as long-term user engagement metrics are often noisy (e.g., influenced by external factors), delayed, or hard to attribute to individual recommendations.

Another drawback is that traditional recommendation systems may not consider the personalized nature of user preferences. For example, on a video streaming platform, a recommendation system may recommend the same movie or TV show to a user who prefers to discover new content and to a user who prefers to re-watch content. Traditional recommendation systems use global optimization to generate recommendations following a fixed strategy. Such global optimization approaches do not consider the personalized nature of user preferences, thereby leading to inaccurate recommendations and a poor overall user experience.

As the foregoing illustrates, what is needed in the art are more effective techniques for generating personalized recommendations.

### SUMMARY

One embodiment sets forth a method for generating a trained recommendation model. According to some embodiments, the method can be implemented by a computing device, and includes the steps of receiving user interaction data for a plurality of users; generating a plurality of user cohorts based on the user interaction data; assigning, to each user cohort in the plurality of user cohorts, a personalized proxy reward function; generating, for each user cohort included in the plurality of user cohorts, an expected long-term reward for the user cohort based on the personalized proxy reward function; and for each user cohort included in the plurality of user cohorts, updating the personalized proxy reward function based on the expected long-term reward for the user cohort, and generating a recommendation policy based on the personalized proxy reward function for the user cohort.

Further embodiments provide, among other things, non-transitory computer-readable storage media storing instructions and systems configured to implement the method set forth above.

At least one technical advantage of the disclosed techniques relative to the prior art is that the recommendation model is trained to maximize long-term user rewards by using a proxy-reward function personalized to each user or to a group of users. As a result, the recommendation model recommends content that engages users in the short-term and enhances long-term satisfaction for users. Another advantage of the disclosed techniques is the allocation of a personalized proxy reward function to each user or to a group of users, which reflects the personalized nature of user preferences. As a result, the long-term satisfaction of different users may be better maximized under different proxy reward functions.

These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a network infrastructure used to distribute content to content servers and endpoint devices, according to various embodiments;

FIG. 2 is a block diagram of a content server that may be implemented in conjunction with the network infrastructure of FIG. 1, according to various embodiments;

FIG. 3 is a block diagram of a control server that may be implemented in conjunction with the network infrastructure of FIG. 1, according to various embodiments;

FIG. 4 is a block diagram of an endpoint device that may be implemented in conjunction with the network infrastructure of FIG. 1, according to various embodiments;

FIG. 5 is a block diagram of a computer-based system according to various embodiments;

FIG. 6 is a more detailed illustration of the reward allocation policy trainer of FIG. 5, according to various embodiments;

FIG. 7 is a more detailed illustration of the recommendation application trainer of FIG. 5, according to various embodiments;

FIG. 8 is a more detailed illustration of the recommendation application of FIG. 5, according to various embodiments;

FIG. 9 sets forth a flow diagram of method steps for training the recommendation model of FIG. 5, according to various embodiments; and

FIG. 10 sets forth a flow diagram of method steps for generating recommendations, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

Recommendation systems frequently employ machine learning techniques that analyze a user's past behavior to generate personalized suggestions. These systems are widely deployed in domains such as audio and video streaming services, social media platforms, and e-commerce. For instance, a streaming service might recommend movies and TV shows based on viewing history, while an online retailer might match customers with products aligned to prior purchases. Traditional recommendation systems generally adopt one of two main approaches: content filtering or collaborative filtering. Content filtering recommends items with attributes similar to those a user has previously engaged with, such as a movie of a similar genre. Collaborative filtering, by contrast, recommends items favored by other users who share similar preferences, often relying on data such as ratings or purchase histories.

Despite their prevalence, traditional recommendation systems suffer from several drawbacks. These systems often optimize for short-term engagement signals-such as skips, likes, or playlist additions-without adequately capturing long-term engagement, including subscription renewals or overall satisfaction. Direct optimization of long-term metrics is difficult because such data is noisy, delayed, and hard to attribute to specific recommendations. In addition, global optimization strategies commonly used in these systems fail to account for individual differences in user preferences. For example, a recommendation might treat a user who enjoys rewatching familiar content the same as a user who prefers constant novelty, resulting in irrelevant suggestions and a diminished user experience.

To address the foregoing technical drawbacks, the embodiments set forth a recommendation system is trained to maximize a personalized proxy reward that approximates the long-term engagement of a user. First, user cohorts are generated using logged short-term and long-term user interaction data. User cohorts may be manually defined, automatically learned using a policy tree algorithm, or consist of an individual user. Then, a reward allocation policy is trained to allocate a personalized proxy reward function to each user cohort. The personalized proxy reward function consists of a linear combination of short-term rewards and personalized weights. The reward allocation policy is learned by first estimating the expected long-term reward within each user cohort and then selecting the personalized proxy reward function that maximizes the estimated long-term reward in each user cohort. In cases where each user cohort consists of an individual user, the reward allocation policy is learned by iterating gradient ascents according to an inverse propensity score estimate of the gradient. Subsequently, an action-level policy is trained using the personalized proxy reward functions learned by the reward allocation policy.

At least one technical advantage of the disclosed techniques relative to the prior art is that the recommendation model is trained to maximize long-term user rewards by using a proxy-reward function personalized to each user or to a group of users. As a result, the recommendation model recommends content that engages users in the short-term and enhances long-term satisfaction for users. Another advantage of the disclosed techniques is the allocation of a personalized proxy reward function to each user or to a group of users, which reflects the personalized nature of user preferences. As a result, the long-term satisfaction of different users may be better maximized under different proxy reward functions.

These technical advantages represent one or more technological improvements over prior art approaches.

### System Overview

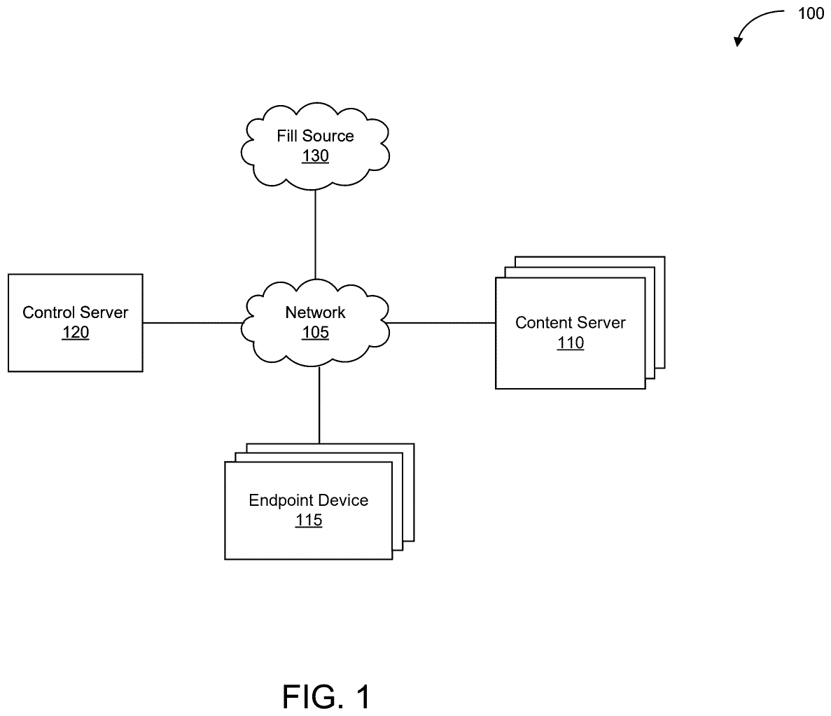

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. Such downloadable content, also referred to herein as a “file,” is then presented to a user of one or more endpoint devices 115. In various embodiments, the endpoint devices 115 may include computer systems, set-top boxes, mobile computers, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content, such as text, images, video, and/or audio content, to a user.

Each content server 110 may include a web server, database, and server application 217 configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content servers 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

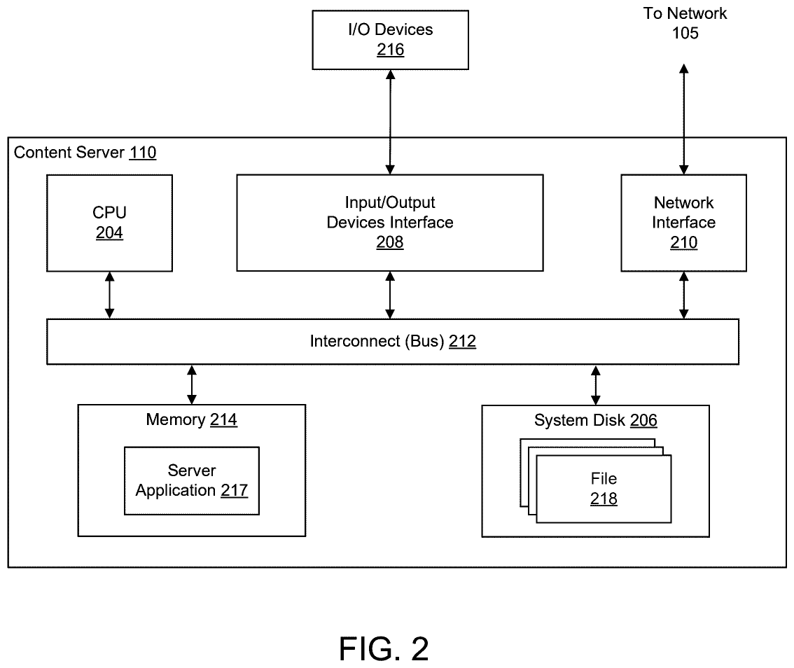

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid-state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

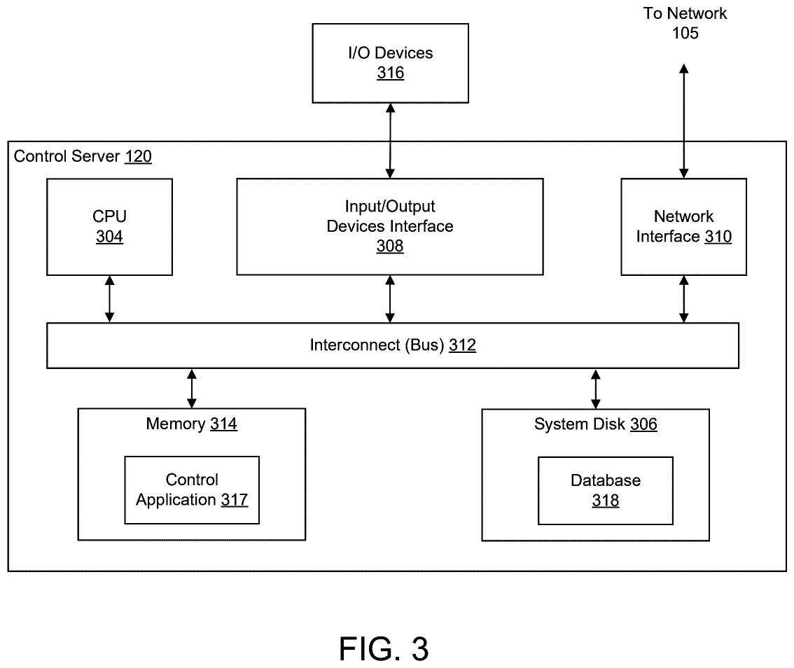

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

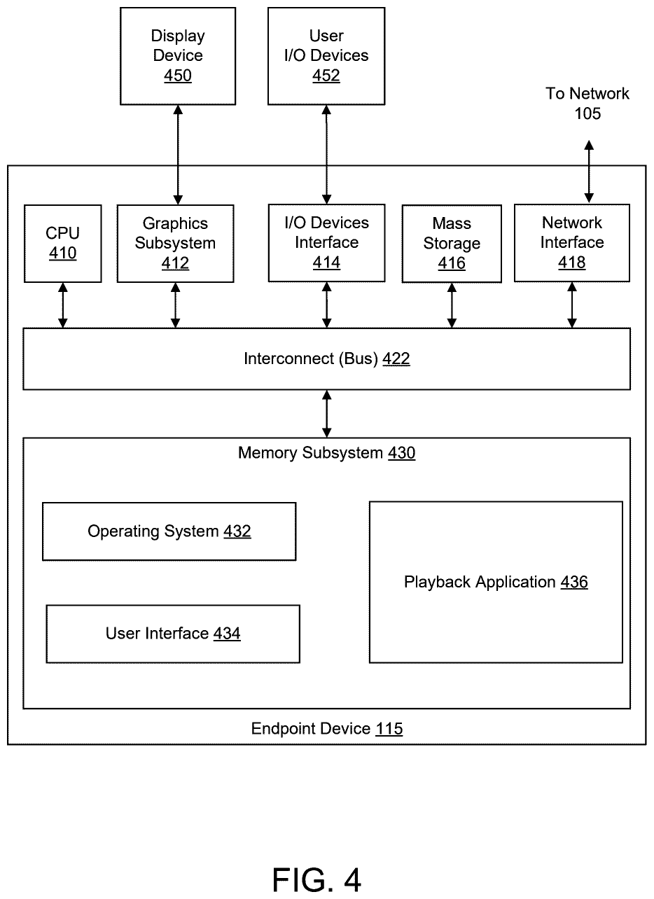

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage unit 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one or more buttons, a keyboard, and a mouse or other pointing device. The I/O device interface 414 also includes an audio output unit configured to generate an electrical audio output signal. User I/O devices 452 include a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452.

### Personalized Recommendation Using Reward Allocation Policy

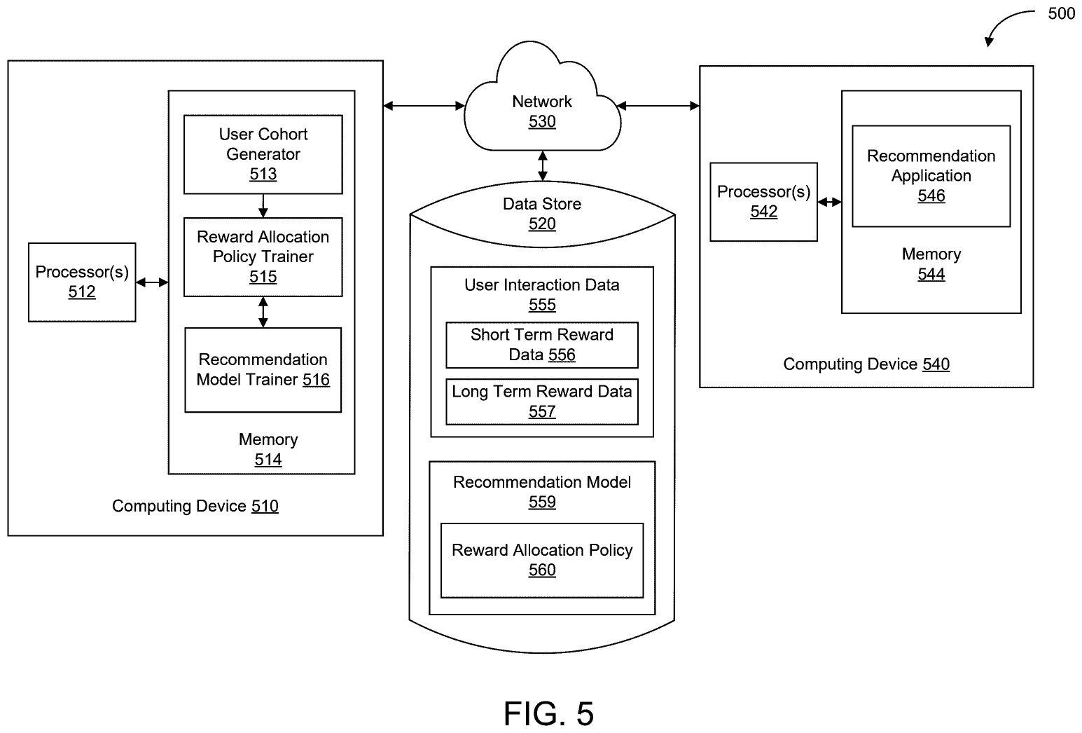

FIG. 5 is a block diagram of a computer-based system 500 according to various embodiments. As shown, computer-based system 500 includes, without limitation, computing devices 510 and 540, a data store 520, and a network 530. Computing device 510 includes, without limitation, one or more processors 512 and memory 514. Memory 514 includes, without limitation, a user cohort generator 513, a reward allocation policy trainer 515, and a recommendation model trainer 516. Data store 520 includes, without limitation, user interaction data 555 and a recommendation model 559. User interaction data 555 includes, without limitation, short-term reward data 556 and long-term reward data 557. Recommendation model 559 includes, without limitation, reward allocation policy 560. Computing device 540 includes, without limitation, one or more processors 542 and memory 544. Memory 544 includes, without limitation, a recommendation application 546. Although FIG. 5 is described in the context of recommendation systems, it is understood that the disclosed techniques are also applicable to other areas of personalization and data-driven systems, such as targeted advertising platforms, product recommendation engines, dynamic user interface customization, personalized educational content delivery, and/or the like.

Computing device 510 shown herein is for illustrative purposes only, and variations and modifications in the design and arrangement of computing device 510 are possible without departing from the scope of the present disclosure. For example, the number of processors 512, the number and/or type of memories 514, and/or the number of applications and/or data stored in memory 514 can be modified as desired. In some embodiments, any combination of processor(s) 512 and/or memories 514 can be included in and/or replaced with any type of virtual computing system, distributed computing system, and/or cloud computing environment, such as a public, private, or a hybrid cloud system.

Each of the processors 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications.

Memory 514 of computing device 510 stores content, such as software applications and data, for use by processors 512. As shown, memory 514 includes, without limitation, a user cohort generator 513, a reward allocation policy trainer 515, and a recommendation model trainer 516. Memory 514 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 514. The storage can include any number and type of external memories that are accessible to processors 512. For example, and without limitation, the storage can include a Secure Digital Card, an external Flash memory, a portable CD-ROM, an optical storage device, a magnetic storage device, and/or any suitable combination of the foregoing.

User cohort generator 513 uses user interaction data 555 to assign each user to a user cohort. In various embodiments, user cohort generator 513 assigns each user to a user cohort based on one or more features of user interaction data 555. For example, and without limitation, features of user interaction data 555 may include demographic information of the user, viewing history, or search queries. In other embodiments, user cohort generator 513 assigns each user to a user cohort automatically by applying a policy tree algorithm to user interaction data 555. The policy tree algorithm builds a tree using user interaction data 555 to partition the space of all users into user cohorts. In other embodiments, each individual user is considered a user cohort.

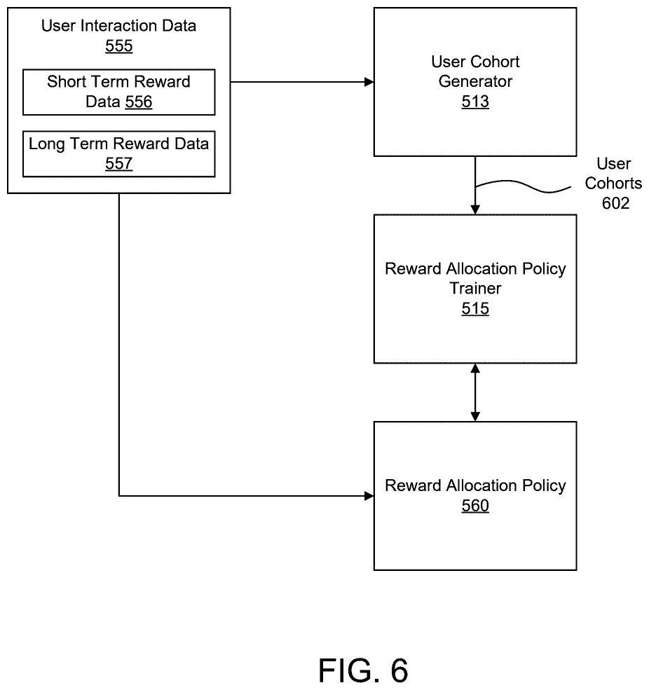

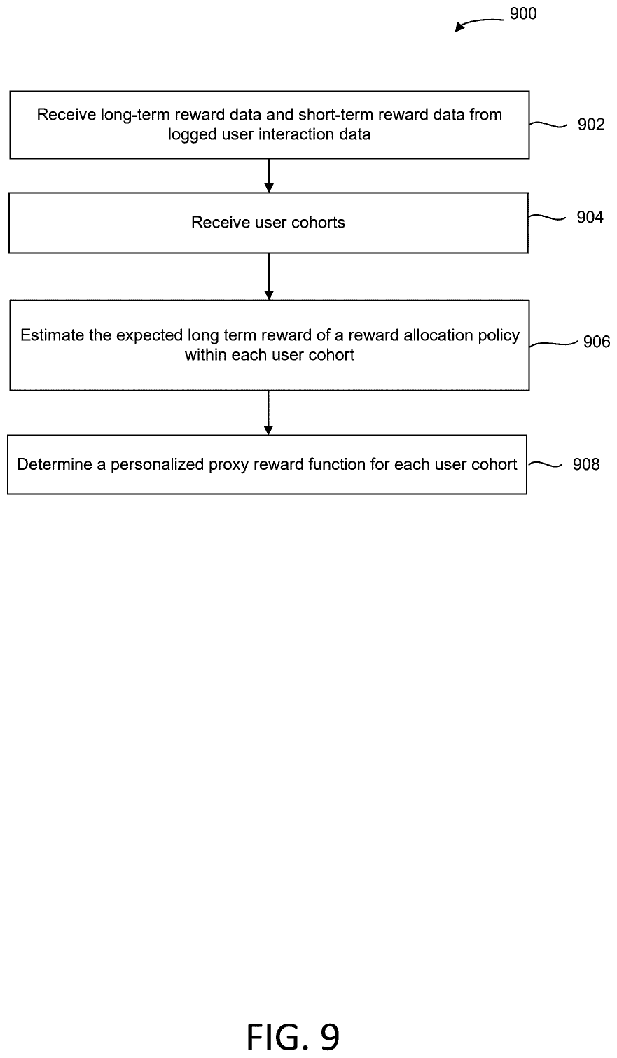

Reward allocation policy trainer 515 trains reward allocation policy 560 using user interaction data 555. In various embodiments, reward allocation policy trainer 515 trains reward allocation policy 560 using user interaction data 555 to assign a personalized proxy reward function to a user cohort generated by user cohort generator 513. In various embodiments, and without limitation, a personalized proxy reward function, ƒᵤ, is a linear combination of short-term rewards and personalized weights given according to equation (1):

$${f}_{u} ( u , a ) = {α}_{1 u} \times {s}_{1} ( u , a ) + {α}_{2 u} \times {s}_{2} ( u , a ) + … + {α}_{n u} \times {s}_{n} ( u , a ) \qquad ( 1 )$$

where u is the user, a is the recommendation produced by the recommendation policy π from the set of all possible recommendations A, s₁, . . . , sₙ are short-term rewards, and β₁ᵤ, . . . , αₙᵤ are constants that depend on u. The dataset utilized by reward allocation policy trainer 515 is divided into training, validation, and test sets. The test set remains independent of the training and validation data to ensure unbiased evaluation. In at least one embodiment, the training process of reward allocation policy 560 uses supervised or unsupervised learning techniques to maximize the expected long-term reward. Reward allocation policy trainer 515 is described in more detail in conjunction with FIGS. 6 and 9.

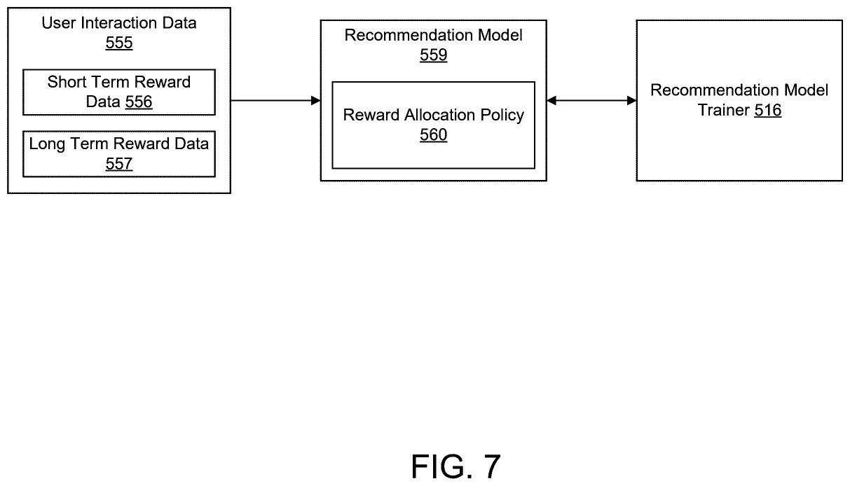

Recommendation model trainer 516 trains recommendation model 559 using user interaction data 555. In various embodiments, recommendation model trainer 516 trains recommendation model 559 to give a recommendation to a user based on the personalized proxy reward function assigned to the user by the reward allocation policy. Recommendation model trainer 516 is described in more detail in conjunction with FIG. 7.

Data store 520 can include any storage device or devices, such as fixed disc drive(s), flash drive(s), optical storage, network-attached storage (NAS), and/or a storage area network (SAN). Although shown as accessible over network 530, in some embodiments computing device 510 can include data store 520. As shown, data store 520 is storing, without limitation, user interaction data 555 and recommendation model 559.

User interaction data 555 includes broad patterns of user behavior and activity across various recommendation tasks, providing insights into what the user engages with, how the user interacts, and the preferences of the user over time. User interaction data includes, without limitation, short-term reward data 556 and long-term reward data 557. Short-term reward data 556 includes user interaction information such as skips, plays, thumbs up/down evaluations, or adding items to a playlist. For example, in a video streaming platform, short-term reward data 556 can include clicks and viewing history. In an e-commerce platform, short-term reward data 555 can include product views, items added to carts, purchase history, and/or the like. In a social media platform, short-term reward data 555 can include likes, shares, comments, and profile visits. Long-term reward data 557 includes user interaction information such as time spent in an application, watching a video to completion, or renewing a subscription. For example, in a video streaming platform, long-term reward data 557 can include watch time for specific genres and interactions such as pausing or skipping content. In an e-commerce platform, long-term reward data 557 can include time spent on product pages, the frequency of returning to certain categories, and/or the like.

Recommendation model 559 is a machine learning model that includes reward allocation policy 560 and processes user inputs to generate recommendations. Recommendation model 559 then determines a recommendation for the user based on the personalized proxy reward function given to the user by reward allocation policy 560.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, with variations and modifications in the design and arrangement of computing device 540 possible without departing from the scope of the present disclosure. For example, the number of processors 542, the number and/or type of memories 544, and/or the number of applications and/or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or hybrid cloud system.

Each of processor(s) 542 can be any suitable processor, such as a CPU, a GPU, an ASIC, an FPGA, a DSP, a multicore processor, and/or any other type of processing unit, or a combination of two or more of the same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user inputs and item inputs from input devices (not shown), such as a keyboard or a mouse.

Memory 544 of computing device 540 stores content, such as software applications and data, for use by processor(s) 542. As shown, memory 544 includes, without limitation, a recommendation application 546. Memory 544 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

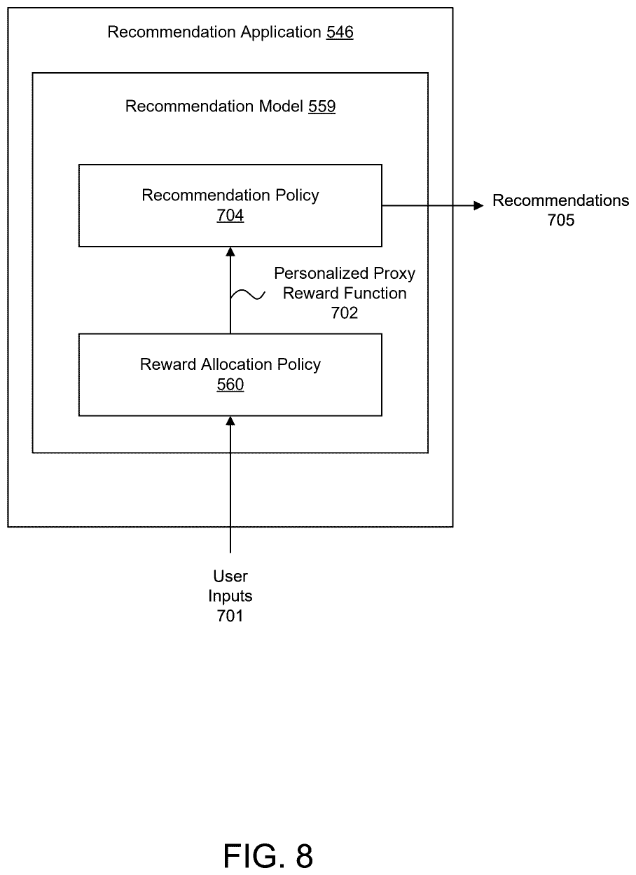

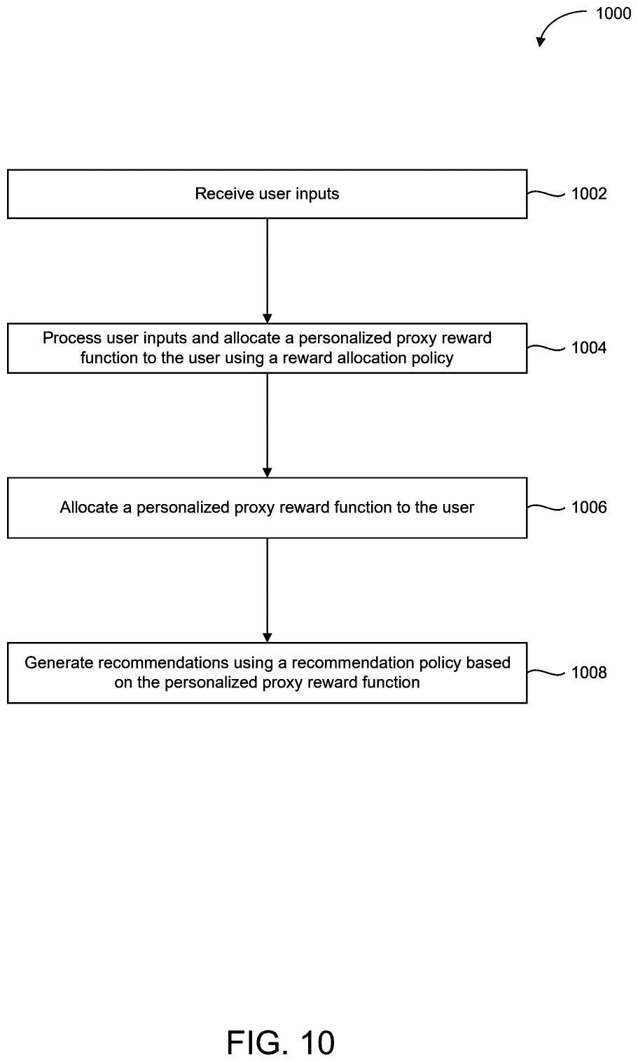

Recommendation application 546 processes user inputs and generates recommendations. User inputs include, without limitation, real-time interactions, such as clicks, searches, likes, plays, and other immediate user activities on the recommendation platform. In various embodiments, recommendation application 546 receives user inputs through various I/O devices (not shown), including direct interactions, browsing activity, and implicit feedback, such as engagement duration and skipped items, and/or the like. Recommendation application 546 is described in more detail in conjunction with FIGS. 8 and 10.

FIG. 6 provides a more detailed illustration of the reward allocation policy trainer 515, according to various embodiments. As shown, reward allocation policy trainer 515 uses user interaction data 555 and user cohorts 602 to train reward allocation policy 560. Reward allocation policy trainer 515 trains reward allocation policy 560 to learn a policy u to assign a personalized proxy reward function ƒ to a user u.

In operation, reward allocation policy trainer 515 receives user cohorts 602 from user cohort generator 513. User cohort generator 513 generates user cohorts 602 from user interaction data 555. In various embodiments, each user cohort 602 includes at least one user that is allocated to the user cohort 602. Reward allocation policy trainer 515 then assigns a personalized proxy reward function to each user cohort 602 according to a policy μ₀. Next, reward allocation policy trainer 515 prepares user cohorts 602 by splitting user cohorts 602 into training, validation, and test datasets. Reward allocation policy trainer 515 then estimates the expected long-term reward, \hat{r} (c, ƒ), within each user cohort 602, c, in the training dataset with personalized proxy reward function, ƒ. In various embodiments, where each user cohort 602 in the training set contains one or more users, reward allocation policy trainer 515 estimates the expected long-term reward of the reward allocation policy within each user cohort 602 in the training dataset according to equation (2)

$$\hat{r} ( c , f ) := \frac{1}{{\sum }_{u ∈ U} I [ {c}_{u} = c , {f}_{u} = f ]} {\sum }_{u ∈ U} {r}_{u} I [ {c}_{u} = c , {f}_{u} = f ] \qquad ( 2 )$$

where cᵤ is the cohort index of a user u, ƒᵤ is the personalized proxy reward function allocated to the user cohort 602 containing user u, rᵤ is the long-term reward for a user u under a policy π, and I is the indicator function. Reward allocation policy trainer 515 then determines the personalized proxy reward function by taking the argument of the maxima (argmax) of the estimated long-term reward. The argmax of a function over a set is the element or elements of that set that maximize the value of the function. Reward allocation policy trainer 515 determines the personalized proxy reward function in the set of personalized proxy reward functions allocated to the user cohorts 602 in the training set that maximizes the expected long-term reward of the reward allocation policy within each user cohort 602 according to equation (3):

$$\hat{{f}_{c}} = arg {max}_{f ∈ μ} \hat{r} ( c , f ) \qquad ( 3 )$$

In other embodiments, where each user cohort 602 in the training dataset contains exactly one user, reward allocation policy trainer 515 learns the personalized proxy reward allocation policy, u, by iterating gradient ascents according to a policy gradient estimate based on an inverse propensity score given according to equation (4):

$${∇}_{ϕ} \hat{r} ( u , μ ) = {\sum }_{( {x}_{u} , {f}_{u} , {r}_{u} ) ∈ {D}_{u}} \frac{{μ}_{ϕ} ( {f}_{u} \vert {x}_{u} )}{{μ}_{0} ( {f}_{u} \vert {x}_{u} )} {r}_{u} {∇}_{ϕ} log {μ}_{ϕ} ( {f}_{u} \vert {x}_{u} ) \qquad ( 4 )$$

where xᵤ are the features of the user interaction data of a user μ, μ₀ is the policy that collected the dataset Dᵤ, ƒᵤ is the personalized proxy reward function allocated to user u by the policy μ₀, rᵤ is the observed long-term reward for a user u under the policy μ₀, and φ is the parameters of the model u.

FIG. 7 is a more detailed illustration of the recommendation model trainer 516, according to various embodiments. As shown, recommendation model trainer 516 uses user interaction data 555 and the trained reward allocation policy 560 to train recommendation model 559. Recommendation model trainer 516 trains recommendation model 559 to learn a recommendation policy to generate a recommendation to a user based on the personalized proxy reward function allocated to that user by the trained reward allocation policy 560. In various embodiments, recommendation model trainer 516 learns the recommendation policy, π, using a policy gradient method by iterating gradient ascents according to a policy gradient estimate given according to equation (5)

$${∇}_{θ} \hat{r} ( u , π ) = {\sum }_{( {u}_{i} , {a}_{i} , {s}_{i} ) ∈ D} \frac{{π}_{θ} ( {a}_{i} \vert {u}_{i} )}{{π}_{0} ( {a}_{i} \vert {u}_{i} )} {f}_{{u}_{i}} ( {s}_{i} ) {∇}_{θ} log {π}_{θ} ( {a}_{i} \vert {u}_{i} ) \qquad ( 5 )$$

where u is the user, a is a recommendation from the set of all possible recommendations A, ƒᵤ is the personalized proxy reward function allocated to user u by the policy μ_{φ}, s is the short-term reward for a user u given recommendation a, π₀ is the policy that collected the dataset D, and θ is the parameters of the model T.

### Personalized Recommendations Using the Recommendation Model

FIG. 8 is a more detailed illustration of the recommendation application 546 according to various embodiments. Recommendation application uses the trained recommendation model 559 to process user inputs 701 and generates recommendations 705. As shown, recommendation application includes, without limitation, recommendation model 559. Recommendation model 559 includes, without limitation, reward allocation policy 560 and recommendation policy 704.

Recommendation model 559 processes user inputs 701 and generates recommendation 705. User inputs 701 include, without limitation, real-time interactions such as clicks, searches, likes, plays, and other immediate user activities on the recommendation platform. In various embodiments, recommendation model 559 receives user inputs through various I/O devices (not shown), including direct interactions, browsing activity, and implicit feedback, such as engagement duration and skipped items, and/or the like. First, user inputs 701 are passed to reward allocation policy 560. Reward allocation policy 560 processes user inputs 701 and allocates a personalized proxy reward function 702 to the user. In various embodiments, and without limitation, a personalized proxy reward function 702 is a linear combination of short-term rewards for the user and personalized weights. Recommendation policy 704 receives personalized proxy reward function 702. Recommendation policy 704 then generates a recommendation 705 for the user based on personalized proxy reward function 702.

### Training the Reward Allocation Policy

FIG. 9 is a flow diagram of method steps for training the reward allocation policy 560, according to various embodiments. Although the method steps are described in conjunction with the embodiments of FIGS. 1-7, persons skilled in the art will understand that any system configured to perform the method steps, in any order, falls within the scope of the various embodiments.

As shown, a method 900 begins at step 902, where reward allocation policy trainer 515 receives long-term reward data 557 and short-term reward data 556 from logged user interaction data 555. User interaction data 555 includes broad patterns of user behavior and activity across various recommendation tasks, and provides insights into what the user engages with, how the user interacts, and the preferences of the user over time.

At step 904, reward allocation policy trainer 515 receives user cohorts from user cohort generator 513. User cohort generator 513 uses user interaction data 555 to assign each user to a user cohort 602. In various embodiments, user cohort generator 513 assigns each user to a user cohort 602 based on one or more features of user interaction data 555. For example, and without limitation, features of user interaction data 555 may include demographic information of the user, viewing history, or search queries. In other embodiments, user cohort generator 513 assigns each user to a user cohort 602 automatically by applying a policy tree algorithm to user interaction data 555.

At step 906, reward allocation policy trainer 515 estimates the expected long-term reward of the reward allocation policy within each user cohort 602. More specifically, reward allocation policy trainer 515 estimates the expected long-term reward within each user cohort 602 in the training dataset according to equation (2).

At step 908, reward allocation policy trainer 515 determines a personalized proxy reward function for each user cohort 602. In some embodiments, reward allocation policy trainer 515 determines the personalized proxy reward function that maximizes the estimated long-term reward of the reward allocation policy within each user cohort 602 according to equation (3). In other embodiments, reward allocation policy trainer 515 estimates the gradient of the expected long-term reward, then reward allocation policy trainer 515 determines a personalized proxy-reward function by iterating gradient ascents based on a policy gradient estimate given according to equation (4).

### Generating Personalized Recommendations

FIG. 10 sets forth a flow diagram of method steps for generating recommendations 705, according to various embodiments. Although the method steps are described in conjunction with the embodiments of FIGS. 1-8, persons skilled in the art will understand that any system configured to perform the method steps, in any order, falls within the scope of the various embodiments.

A method 1000 begins with step 1002, where recommendation application 546 receives user inputs 701. In various embodiments, recommendation application 546 receives user inputs 701 through various input channels, including real-time interactions such as clicks, searches, likes, plays, and other immediate user activities on the recommendation platform. Additionally, user inputs 701 can be received as the user interacts with different content and/or performs actions within user interfaces associated with the recommendation platform. In some embodiments, recommendation application 546 receives user inputs 701 via voice commands, typed queries, and/or the like. In at least one embodiment, recommendation application 546 receives implicit user inputs 701, such as engagement duration, scrolling behavior, and/or skipped content.

At step 1004, recommendation model 559 processes user inputs 701 using a reward allocation policy 560. In various embodiments, reward allocation policy 560 processes user inputs 701 and determines the user cohort of the user.

At step 1006, reward allocation policy 560 allocates a personalized proxy reward function 702 to the user. More specifically, reward allocation policy 560 allocates a personalized proxy reward function 702 to the user based on the user cohort of the user. In various embodiments, and without limitation, a personalized proxy reward function 702 is a linear combination of short-term rewards for the user and personalized weights.

At step 1008, recommendation policy 704 generates recommendations 705 using a recommendation policy based on the personalized proxy reward function 702. Recommendation policy 704 receives personalized proxy reward function 702. Recommendation policy 704 then generates a recommendation 705 for the user based on personalized proxy reward function 702.

As described herein, a recommendation model 559 is trained by initially training a reward allocation policy 560 to determine a personalized proxy reward function 702 for each user cohort 602. Subsequently, a recommendation policy 704 is trained based on the personalized proxy reward function 702 for each user cohort 602. An alternative approach for training a recommendation model 559 involves first training a set of recommendation policies 704 followed by training a reward allocation policy 560. Under this alternative approach, a personalized proxy reward function 702 is allocated to each recommendation policy 704, which is trained by the recommendation model trainer 516. The set of trained recommendation policies 704, in turn, is used by reward allocation policy trainer 515 to train the reward allocation policy 560. The reward allocation policy trainer 515 then trains the reward allocation policy 560 to allocate the set of trained recommendation policies 704 to each user cohort 602. Such action ensures that the long-term reward of each user cohort 602 is maximized under the deployment of the trained reward allocation policy 560.

In sum, a recommendation system is trained to maximize a personalized proxy reward that approximates the long-term engagement of a user. First, user cohorts are generated using logged short-term and long-term user interaction data. User cohorts may be manually defined, automatically learned using a policy tree algorithm, or consist of an individual user. Then, a reward allocation policy is trained to allocate a personalized proxy reward function to each user cohort. The personalized proxy reward function consists of a linear combination of short-term rewards and personalized weights. The reward allocation policy is learned by first estimating the expected long-term reward within each user cohort and then selecting the personalized proxy reward function that maximizes the estimated long-term reward in each user cohort. In cases where each user cohort consists of an individual user, the reward allocation policy is learned by iterating gradient ascents according to an inverse propensity score estimate of the gradient. Subsequently, an action-level policy is trained using the personalized proxy reward functions learned by the reward allocation policy.

At least one technical advantage of the disclosed techniques relative to the prior art is that the recommendation model is trained to maximize long-term user rewards by using a proxy-reward function personalized to each user or to a group of users. As a result, the recommendation model recommends content that engages users in the short-term and enhances long-term satisfaction for users. Another advantage of the disclosed techniques is the allocation of a personalized proxy reward function to each user or to a group of users, which reflects the personalized nature of user preferences. As a result, the long-term satisfaction of different users may be better maximized under different proxy reward functions.

Aspects of the subject matter described herein are set out in the following numbered clauses.

1. In some embodiments, a method for generating a trained recommendation model comprises: receiving user interaction data for a plurality of users; generating a plurality of user cohorts based on the user interaction data; assigning, to each user cohort in the plurality of user cohorts, a personalized proxy reward function; generating, for each user cohort included in the plurality of user cohorts, an expected long-term reward for the user cohort based on the personalized proxy reward function; and for each user cohort included in the plurality of user cohorts: updating the personalized proxy reward function based on the expected long-term reward for the user cohort, and generating a recommendation policy based on the personalized proxy reward function for the user cohort.

2. The computer-implemented method of clause 1, wherein generating the plurality of user cohorts comprises automatically assigning each user included in the plurality of users to a user cohort included in the plurality of user cohorts by applying a policy tree algorithm.

3. The computer-implemented method of any of clauses 1-2, wherein updating, for each user cohort included in the plurality of user cohorts, the personalized proxy reward function comprises taking the argument of a maxima of the expected long-term reward for the user cohort over the personalized proxy reward functions assigned to the plurality of user cohorts.

4. The computer-implemented method of any of clauses 1-3, wherein updating, for each user cohort included in the plurality of user cohorts, the personalized proxy reward function comprises iterating gradient ascents of the expected long-term reward.

5. The computer-implemented method of any of clauses 1-4, wherein the personalized proxy reward function is a linear combination of a plurality of short-term rewards and a plurality of personalized weights.

6. The computer-implemented method of any of clauses 1-5, wherein generating, for each user cohort included in the plurality of user cohorts, the recommendation policy based on the personalized proxy reward function for the user cohort comprises iterating gradient ascents of the expected long-term reward of the recommendation policy.

7. The computer-implemented method of any of clauses 1-6, wherein each user cohort included in the plurality of user cohorts corresponds to a different user included in the plurality of users.

8. The computer-implemented method of any of clauses 1-7, further comprising generating, via the trained recommendation model, a recommendation for at least one user cohort included in the plurality of user cohorts based on the personalized proxy reward function for the at least one user cohort and the recommendation policy for the at least one user cohort.

9. The computer-implemented method of any of clauses 1-8, further comprising generating a recommendation for at least one user included in the plurality of users by: determining, based on at least one user input, a user cohort included in the plurality of user cohorts that is associated with the at least one user; determining the personalized proxy reward function based on the user cohort; determining the recommendation policy based on the personalized proxy reward function; and generating, via the trained recommendation model, the recommendation based on the personalized proxy reward function and the recommendation policy.

10. The computer-implemented method of any of clauses 1-9, further comprising performing at least one action based on at least one of the recommendation policies, wherein the at least one action comprises at least one of recommending at least one media asset or displaying at least one advertisement.

11. In some embodiments, one or more non-transitory computer readable media store instructions that, when executed by one or more processors, cause the one or more processors to generate a trained recommendation model, by performing the operations of: receiving user interaction data for a plurality of users; generating a plurality of user cohorts based on the user interaction data; assigning, to each user cohort in the plurality of user cohorts, a personalized proxy reward function; generating, for each user cohort included in the plurality of user cohorts, an expected long-term reward for the user cohort based on the personalized proxy reward function; and for each user cohort included in the plurality of user cohorts: updating the personalized proxy reward function based on the expected long-term reward for the user cohort, and generating a recommendation policy based on the personalized proxy reward function for the user cohort.

12. The one or more non-transitory computer readable media of clause 11, wherein generating the plurality of user cohorts comprises automatically assigning each user included in the plurality of users to a user cohort included in the plurality of user cohorts by applying a policy tree algorithm.

13. The one or more non-transitory computer readable media of any of clauses 11-12, wherein updating, for each user cohort included in the plurality of user cohorts, the personalized proxy reward function comprises taking the argument of a maxima of the expected long-term reward for the user cohort over the personalized proxy reward functions assigned to the plurality of user cohorts.

14. The one or more non-transitory computer readable media of any of clauses 11-13, wherein updating, for each user cohort included in the plurality of user cohorts, the personalized proxy reward function comprises iterating gradient ascents of the expected long-term reward.

15. The one or more non-transitory computer readable media of any of clauses 11-14, wherein the personalized proxy reward function is a linear combination of a plurality of short-term rewards and a plurality of personalized weights.

16. The one or more non-transitory computer readable media of any of clauses 11-15, wherein generating, for each user cohort included in the plurality of user cohorts, the recommendation policy based on the personalized proxy reward function for the user cohort comprises iterating gradient ascents of the expected long-term reward of the recommendation policy.

17. The one or more non-transitory computer readable media of any of clauses 11-16, wherein each user cohort included in the plurality of user cohorts corresponds to a different user included in the plurality of users.

18. The one or more non-transitory computer readable media of any of clauses 11-17, wherein user interaction data for a user comprises short-term reward data and long-term reward data for the user.

19. The one or more non-transitory computer readable media of any of clauses 11-18, wherein short-term reward data for a user comprises clicks and viewing history of the user.

20. In some embodiments, a computer system comprises one or more memories that include instructions, and one or more processors that are coupled to the one or more memories and that, when executing the instructions, are configured to generate a trained recommendation model, by performing the operations of: receiving user interaction data for a plurality of users; generating a plurality of user cohorts based on the user interaction data; assigning, to each user cohort in the plurality of user cohorts, a personalized proxy reward function; generating, for each user cohort included in the plurality of user cohorts, an expected long-term reward for the user cohort based on the personalized proxy reward function, and for each user cohort included in the plurality of user cohorts: updating the personalized proxy reward function based on the expected long-term reward for the user cohort, and generating a recommendation policy based on the personalized proxy reward function for the user cohort.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for generating a trained recommendation model, the method comprising:
receiving user interaction data for a plurality of users;
generating a plurality of user cohorts based on the user interaction data;
assigning, to each user cohort in the plurality of user cohorts, a personalized proxy reward function;
generating, for each user cohort included in the plurality of user cohorts, an expected long-term reward for the user cohort based on the personalized proxy reward function; and
for each user cohort included in the plurality of user cohorts:
updating the personalized proxy reward function based on the expected long-term reward for the user cohort, and
generating a recommendation policy based on the personalized proxy reward function for the user cohort.

2. The computer-implemented method of claim 1, wherein generating the plurality of user cohorts comprises automatically assigning each user included in the plurality of users to a user cohort included in the plurality of user cohorts by applying a policy tree algorithm.

3. The computer-implemented method of claim 1, wherein updating, for each user cohort included in the plurality of user cohorts, the personalized proxy reward function comprises taking the argument of a maxima of the expected long-term reward for the user cohort over the personalized proxy reward functions assigned to the plurality of user cohorts.

4. The computer-implemented method of claim 1, wherein updating, for each user cohort included in the plurality of user cohorts, the personalized proxy reward function comprises iterating gradient ascents of the expected long-term reward.

5. The computer-implemented method of claim 1, wherein the personalized proxy reward function is a linear combination of a plurality of short-term rewards and a plurality of personalized weights.

6. The computer-implemented method of claim 1, wherein generating, for each user cohort included in the plurality of user cohorts, the recommendation policy based on the personalized proxy reward function for the user cohort comprises iterating gradient ascents of the expected long-term reward of the recommendation policy.

7. The computer-implemented method of claim 1, wherein each user cohort included in the plurality of user cohorts corresponds to a different user included in the plurality of users.

8. The computer-implemented method of claim 1, further comprising generating, via the trained recommendation model, a recommendation for at least one user cohort included in the plurality of user cohorts based on the personalized proxy reward function for the at least one user cohort and the recommendation policy for the at least one user cohort.

9. The computer-implemented method of claim 1, further comprising generating a recommendation for at least one user included in the plurality of users by:
determining, based on at least one user input, a user cohort included in the plurality of user cohorts that is associated with the at least one user;
determining the personalized proxy reward function based on the user cohort;
determining the recommendation policy based on the personalized proxy reward function; and
generating, via the trained recommendation model, the recommendation based on the personalized proxy reward function and the recommendation policy.

10. The computer-implemented method of claim 1, further comprising performing at least one action based on at least one of the recommendation policies, wherein the at least one action comprises at least one of recommending at least one media asset or displaying at least one advertisement.

11. One or more non-transitory computer readable media storing instructions that, when executed by one or more processors, cause the one or more processors to generate a trained recommendation model, by performing the operations of:
receiving user interaction data for a plurality of users;
generating a plurality of user cohorts based on the user interaction data;
assigning, to each user cohort in the plurality of user cohorts, a personalized proxy reward function;
generating, for each user cohort included in the plurality of user cohorts, an expected long-term reward for the user cohort based on the personalized proxy reward function; and
for each user cohort included in the plurality of user cohorts:
updating the personalized proxy reward function based on the expected long-term reward for the user cohort, and
generating a recommendation policy based on the personalized proxy reward function for the user cohort.

12. The one or more non-transitory computer readable media of claim 11, wherein generating the plurality of user cohorts comprises automatically assigning each user included in the plurality of users to a user cohort included in the plurality of user cohorts by applying a policy tree algorithm.

13. The one or more non-transitory computer readable media of claim 11, wherein updating, for each user cohort included in the plurality of user cohorts, the personalized proxy reward function comprises taking the argument of a maxima of the expected long-term reward for the user cohort over the personalized proxy reward functions assigned to the plurality of user cohorts.

14. The one or more non-transitory computer readable media of claim 11, wherein updating, for each user cohort included in the plurality of user cohorts, the personalized proxy reward function comprises iterating gradient ascents of the expected long-term reward.

15. The one or more non-transitory computer readable media of claim 11, wherein the personalized proxy reward function is a linear combination of a plurality of short-term rewards and a plurality of personalized weights.

16. The one or more non-transitory computer readable media of claim 11, wherein generating, for each user cohort included in the plurality of user cohorts, the recommendation policy based on the personalized proxy reward function for the user cohort comprises iterating gradient ascents of the expected long-term reward of the recommendation policy.

17. The one or more non-transitory computer readable media of claim 11, wherein each user cohort included in the plurality of user cohorts corresponds to a different user included in the plurality of users.

18. The one or more non-transitory computer readable media of claim 11, wherein user interaction data for a user comprises short-term reward data and long-term reward data for the user.

19. The one or more non-transitory computer readable media of claim 11, wherein short-term reward data for a user comprises clicks and viewing history of the user.

20. A computer system, comprising:
one or more memories that include instructions; and
one or more processors that are coupled to the one or more memories and that,
when executing the instructions, are configured to generate a trained recommendation model, by performing the operations of:
receiving user interaction data for a plurality of users;
generating a plurality of user cohorts based on the user interaction data;
assigning, to each user cohort in the plurality of user cohorts, a personalized proxy reward function;
generating, for each user cohort included in the plurality of user cohorts, an expected long-term reward for the user cohort based on the personalized proxy reward function; and
for each user cohort included in the plurality of user cohorts:
updating the personalized proxy reward function based on the expected long-term reward for the user cohort, and
generating a recommendation policy based on the personalized proxy reward function for the user cohort.
